(19) United States
(12) Patent Application Publication
(10) Pub. No.: US 2010/0259562 A1
(43) Pub. Date: Oct. 14, 2010

(54) DISPLAY CONTROL APPARATUS, DISPLAY CONTROL METHOD AND COMPUTER PROGRAM

(76) Inventors: Yusuke MIYAZAWA, Tokyo (JP); Fuminori Homma, Tokyo (JP); Tatsushi Nashida, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/754,017

(22) Filed: Apr. 5, 2010

(30) Foreign Application Priority Data
Apr. 14, 2009 (JP) P2009-098412

(51) Int. Cl. G09G 5/34; G06F 3/041

(52) U.S. Cl. 345/684; 345/173

(57) ABSTRACT

A display control apparatus is provided which includes a detection unit for detecting proximity of an operation tool to, or contact of the operation tool with, a display unit including a first display area on which an object list in which a plurality of objects are arranged is displayed and a second display area on which the content of the object is displayed, a movement determination unit for determining a movement of the operation tool based on the detection result by the detection unit, a list display control unit for controlling a display of the object list displayed in the first display area based on the determination result by the movement determination unit, and a detailed display control unit for controlling a display of the second display area based on the determination result by the movement determination unit.

### BACKGROUND OF THE INVENTION

1. Field of the Invention

The present invention relates to a display control apparatus, a display control method, and a computer program.

2. Description of the Related Art

In an enlarged display of a web page or photo or a display of detailed information and the like, there are proposed a variety of methods for selecting, from a list, an object to be displayed on large scale on an enlarged display screen or an object whose detailed information is to be displayed on a detailed information screen.

For example, in Japanese Patent No. 4179197, there is disclosed a method for displaying sub-screens each of which is activated by selecting a link destination displayed on a main screen and each of which displays information of the link destination in a manner such that the sub-screens do not overlap to a large extent. According to the method, as shown in FIG. 21 for example, when a plurality of objects displayed on a display unit 11 in a browser 12 are selected by an input means, each content linked to the selected object is obtained, respectively. Subsequently, a display position and a display size of each of sub-windows W1 to W4 are calculated, respectively, in order that the extent of overlapping between the sub-windows W1 to W4 displaying each of the obtained content falls within an allowable range. Then, each of the content is displayed respectively on each of the sub-windows W1 to W4 with the calculated display position and display size on the display unit 11. This enables the extent of overlapping between the sub-windows W1 to W4 to be adjusted and a user to view each of the content displayed on each of the sub-windows W1 to W4 at the same time.

Moreover, in Japanese Unexamined Patent Application Publication No. 2008-204015, there is disclosed a content display apparatus 21 including a screen 22 for displaying a content list 23 and a wheel 24 for performing an operation on the content list 23, as shown in FIG. 22. The content display apparatus 21 can sequentially select the pieces of content contained in the content list 23 by the wheel 24 being rotated. The selected content is displayed on a screen 22. Then, by the wheel 24 being pushed into the body side of the apparatus and rotated, the content displayed on the screen 22 can be scrolled.

Furthermore, an example of a display apparatus 30 including a first display unit 31 and a second display unit 32 is shown in FIG. 23. In the display apparatus 30, the first display unit 31 can be caused to display a list containing thumbnails 35a to 35e of web pages and the like and the second display unit 32 can be caused to display the detailed information of a thumbnail selected from the list. A thumbnail 35a displayed on the first display unit 31 and selected from the list is surrounded by a selection frame 33 and detailed information 37a of the thumbnail 35a is displayed on the display unit 32. According to such display method, it is possible to visually confirm, by the second display unit 32, the detailed information of the thumbnail selected while seeing the list displayed on the display unit 31 of the first display unit 31, and it is possible to facilitate a page switching operation.

### SUMMARY OF THE INVENTION

However, for example, a switching operation of display pages is frequently performed when update information obtained by a RSS (RDF Site Summary, Rich Site Summary) reader or blogs is zapped or a result of web search is displayed. The method described in the Japanese Patent No. 4179197 enables the pieces of information displayed on the sub-windows to be viewed at the same time, but it also requires an operation of closing a sub-window that becomes unnecessary, and it is troublesome to switch display pages between the sub-windows and a browser. Moreover, such a display is difficult on a mobile terminal, the browser of which is not sufficient for the area of a screen for a link destination.

Moreover, the content display apparatus described in the above Japanese Unexamined Patent Application Publication No. 2008-204015 performs an operation of selecting content from the content list and a scroll operation by using the same member (wheel), so that it requires a task of switching operations by pressing the wheel. Moreover, since such content display apparatus is assumed to have a wheel, there is also an issue that a display apparatus including a wheel is limited.

In addition, also in a display method shown in FIG. 23, a selection of a thumbnail and an operation on detailed information have to be performed on different screens, so that there is an issue that a transfer between display units has to be frequently performed. Thus, with the related method described above, it is difficult to seamlessly perform an operation of selecting an object whose detailed information is to be displayed from a list and an operation on the displayed information.

In light of the foregoing, it is desirable to provide a display control apparatus, a display control method, and a computer program which are novel and improved, and which are capable of reducing user's operational burden.

According to an embodiment of the present invention, there is provided a display control apparatus including a detection unit for detecting proximity of an operation tool to, or contact of the operation tool with, a display unit including a first display area on which an object list in which a plurality of objects are arranged is displayed and a second display area on which the content of the object is displayed, a movement determination unit for determining a movement of the operation tool based on the detection result by the detection unit, a list display control unit for controlling a display of the object list displayed in the first display area based on the determination result by the movement determination unit, and a detailed display control unit for controlling a display of the second display area based on the determination result by the movement determination unit. When the movement determination unit determines that one of the objects is selected from the object list displayed in the first display area, the detailed display control unit displays the content of the selected object in the second display area, and the unit detailed display control unit changes a display of the content of the object displayed in the second display area based on the movement of the operation tool in the first display area determined by the movement determination unit.

According to the present invention, there can be performed, in the first display area, the operation of selecting one of the objects from the object list and the operation on the display of the content of the selected object displayed in the second display area. This enables to reduce the movement of moving the operation tool frequently between the display areas for operation, so that user's operational burden can be reduced.

Here, the display control apparatus may include an acquisition unit for obtaining the latest content of the object from an object distribution server which distributes objects and which is connected, and a storage unit for storing therein the object obtained by the acquisition unit. The list display control unit displays in the first display area the object list created by using the latest objects among the objects stored in the storage unit. When determining that one of the objects is selected from the object list displayed in the first display area, the movement determination unit causes the acquisition unit to obtain the latest content of the selected object. Then, the detailed display control unit displays in the second display area the latest content of the selected object obtained by the acquisition unit.

Moreover, when being in a communicable state with the object distribution server, the acquisition unit may obtain the latest content of the object stored in the storage unit and record the latest content in the storage unit at a predetermined timing.

Furthermore, when the movement determination unit determines that, in the first display area, there is a movement of moving the operation tool in a first direction which is a direction substantially orthogonal to an arrangement direction of the objects which composes the object list, the detailed display control unit may scroll the content of the object displayed in the second display area in the first direction.

Moreover, when the movement determination unit determines that, in the first display area, there is a movement of moving the operation tool in a second direction, which is the arrangement direction of the object, within an area corresponding to the selected object, the detailed display control unit may scroll the content of the object displayed in the second display area in the second direction.

Furthermore, when the movement determination unit determines that, in the first display area, there is a movement of moving the operation tool in the second direction, which is the arrangement direction of the object, outside the area corresponding to the selected object, the list display control unit may scroll the object list displayed in the first display area in the second direction.

When the object in the object list corresponding to the content of the object displayed in the second display area is moved outside the first display area, and the movement determination unit determines a contact of the operation tool with the second display area, the list display control unit may display the object list such that the object corresponding to the content of the object displayed in the second display area is displayed.

Furthermore, when the content of the object selected from the object list is a plurality of simplified information, the detailed display control unit may sequentially display in the second display area detailed information corresponding to the simple information at every time the movement detection unit detects a predetermined movement of the operation tool in the area corresponding to the selected object in the first display area.

Moreover, according to another embodiment of the present invention, there is provided a display control method comprising the steps of detecting proximity of an operation tool to, or contact of the operation tool with, a display unit including a first display area on which an object list in which a plurality of objects are arranged is displayed and a second display area on which the content of the object is displayed, determining a movement of the operation tool based on a detection result, displaying the object list in the first display area based on a determination result, displaying the content of the selected object in the second display area when one of the objects is selected from the object list displayed in the first display area, and changing a display of the content of the object displayed in the second display area based on the movement of the operation tool in the first display area.

Furthermore, according to another embodiment of the present invention, there is provided a computer program for causing a computer to function as the device control apparatus described above. The computer program is stored in a storage device included in the computer, and it is read and executed by a CPU included in the computer, thereby causing the computer to function as the device control apparatus described above. Moreover, there is also provided a computer readable recording medium in which the computer program is stored. The recording medium may be a magnetic disk, an optical disk and the like, for example.

According to the embodiments of the present invention described above, a display control apparatus, a display control method, and a computer program which are capable of reducing user's operational burden can be provided.

### BRIEF DESCRIPTION OF THE DRAWINGS

FIG. 1 is an explanatory diagram showing an example of display content controlled by a display control apparatus according to an embodiment of the present invention;

FIG. 2 is a functional block diagram showing a functional configuration of the display control apparatus according to the embodiment;

FIG. 3 is a flowchart showing a display processing method according to the embodiment;

FIG. 4 is an explanatory diagram showing a display example where a piece of content is displayed in two display areas;

FIG. 5 is an explanatory diagram showing a display example where a list of contents is displayed in one display area and a piece of content is displayed in the other display area;

FIG. 6 is an explanatory diagram showing an example of a display displayed after a display processing of the content corresponding to a newly selected thumbnail and a display change processing of a list are performed;

FIG. 7 is an explanatory diagram showing an example of a screen display of the case where content is a document described in RSS;

FIG. 8 is an explanatory diagram showing an example of screen transition of the case where content is a document described in RSS the case where content is a document described in RSS;

FIG. 9 is an explanatory diagram for explaining operations by pinch in/pinch out gestures;

FIG. 10 is an explanatory diagram showing a display example where, when drag is performed in the vertical direction by an operation tool in a first display area, content displayed in a second display area is scrolled in the direction of the drag;

FIG. 11 is an explanatory diagram showing a scroll operation;

FIG. 12 is an explanatory diagram showing a display example where, when drag is performed in the horizontal direction by the operation tool in the first display area, content displayed in the second display area is scrolled in the direction of the drag;

FIG. 13 is an explanatory diagram showing a display example where a thumbnail of the content displayed in the second display area disappears from the first display area by scrolling the list in the first display area;

FIG. 14 is an explanatory diagram showing an example where, when the thumbnail of the content displayed in the second display area disappears from the first display area, the list is scrolled to display the thumbnail of the content;

FIG. 15 is an explanatory diagram showing a display control method by an operation in the second display area according to the embodiment;

FIG. 16 is an explanatory diagram showing a display control method by an operation in the second display area according to the embodiment;

FIG. 17 is an explanatory diagram for explaining a processing of adding a bookmark;

FIG. 18 is an explanatory diagram showing a display processing in the case where content displayed in the second display area is not bookmarked;

FIG. 19 is an explanatory diagram showing a display processing in the case where content displayed in the second display area is bookmarked;

FIG. 20 is a hardware configuration diagram showing a display control apparatus according to the embodiment;

FIG. 21 is an explanatory diagram showing a window display example by a method for viewing pieces of content simultaneously in the related art;

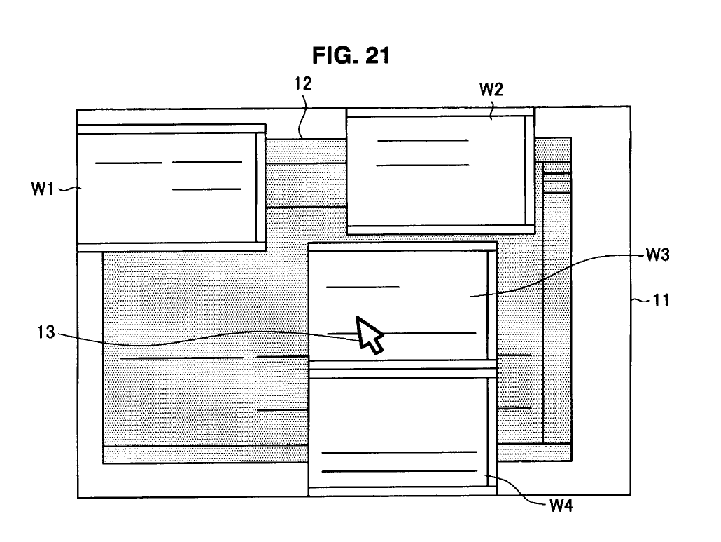

FIG. 22 is an explanatory diagram showing an example of a list selection method by a content display apparatus in the related art; and

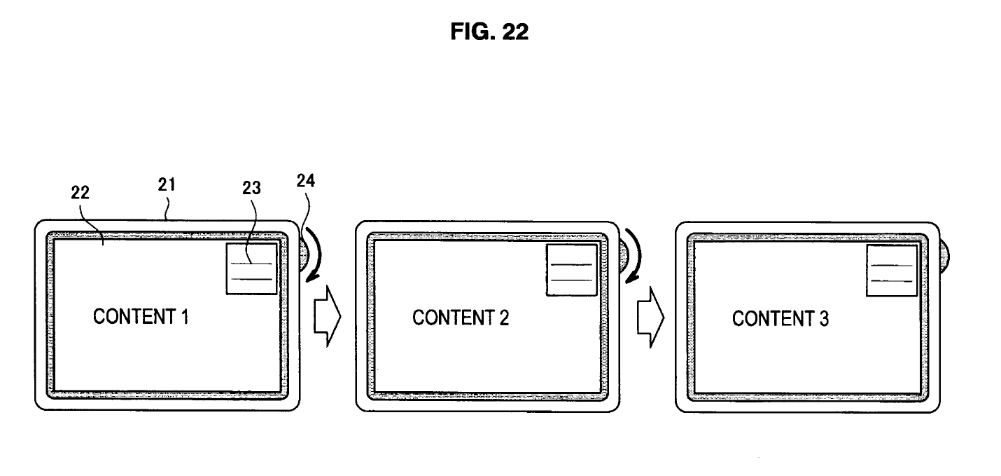

FIG. 23 is an explanatory diagram showing an example of the related art where a thumbnail list and detailed information of the thumbnail selected from the thumbnail list on different screens.

### DETAILED DESCRIPTION OF THE EMBODIMENT

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

In addition, description will be made in the following order.

1. Configuration of display control apparatus

2. Display control method by display control apparatus

3. Hardware configuration example

### <1. Configuration of Display Control Apparatus>

### [Screen Configuration Example]

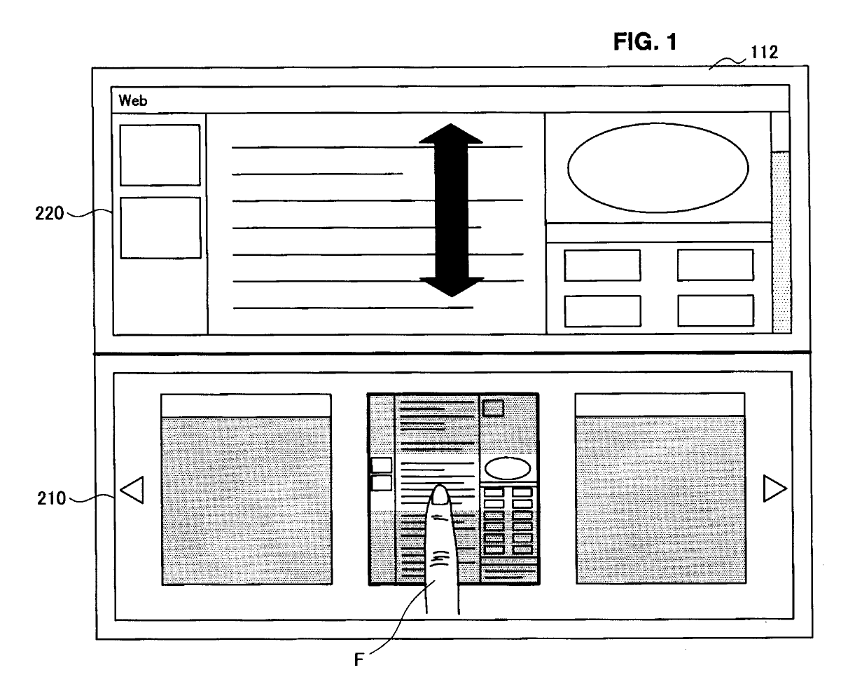

First, there will be described, based on FIG. 1, a configuration example of a screen for displaying display content which is display-controlled by a display control apparatus according to an embodiment of the present invention. In addition, FIG. 1 is an explanatory diagram showing an example of display content controlled by the display control apparatus according to the present embodiment.

In the present embodiment, as shown in FIG. 1, display content which is display-controlled by a display control apparatus is displayed on a display unit 112 including two display areas 210 and 220. The display areas 210 and 220 may be display areas included in one screen or may be two different screens independent of each other. The display unit 112 includes a detection unit capable of detecting proximity of an operation tool to, or contact of the same with the display unit 112. The display control apparatus controls display based on a detection result of the detection unit. By the display control by the display control apparatus, a user can easily perform an operation on display content in the display areas 210 and 220 by moving the operation tool on the surface of the display unit 112, for example.

Between the display areas 210 and 220 that are longitudinally arranged, a list containing an arranged plurality of thumbnails of contents which are objects is displayed in a first display area 210, and detailed information of a thumbnail selected from the list is displayed in a second display area 220, for example. Content includes a web page, a still image, video, document and the like, for example. Moreover, a form of displaying contents as a list includes a form such as a bookmark in which content frequently viewed by the user is registered, a browsing history, a categorized display by a predetermined rule (e.g., documents included in a file), for example. When the user selects a thumbnail from the list displayed in the first display area 210 by touching the thumbnail with a finger F, the content corresponding to the selected thumbnail is displayed in the second display area 220. Then, the user can perform an operation on the display content in the display area 220 by moving the finger F on the first display area 210. For example, when the user moves the finger F in the vertical direction while keeping it in contact with the first display area 210, the display content in the second display area 220 is scrolled in the vertical direction.

In this way, by using the display control apparatus according to the present embodiment, operability on the display content displayed on the display unit 112 can be improved. In the following, a configuration of the display control apparatus according to the present embodiment and a display control method by the same will be described in detail.

### [Functional Configuration of Display Control Apparatus]

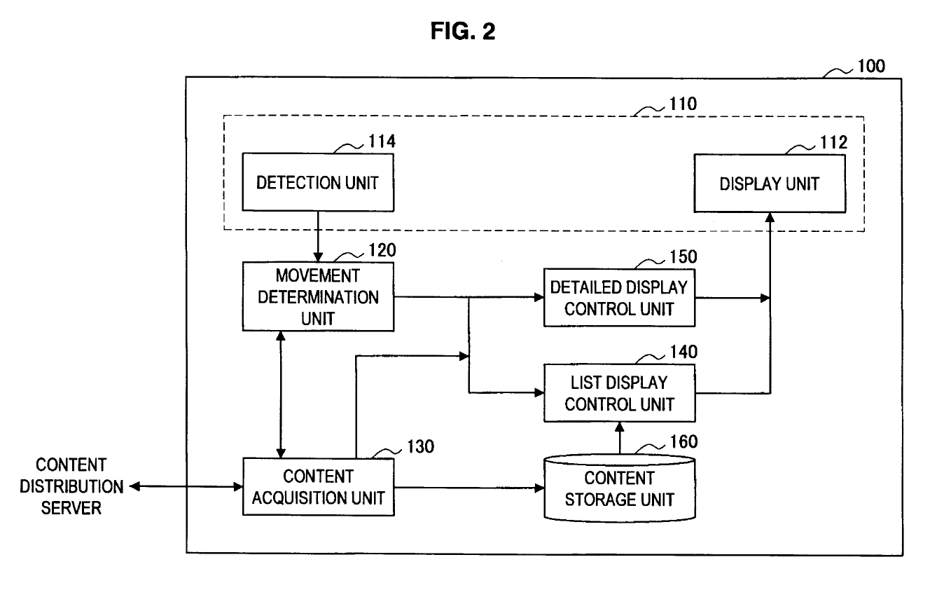

First, a functional configuration of a display control apparatus 100 according to the present embodiment will be described based on FIG. 2. In addition, FIG. 2 is a functional block diagram showing the functional configuration of the display control apparatus 100 according to the present embodiment.

The display control apparatus 100 according to the present embodiment includes a touch panel 110, a movement determination unit 120, a content acquisition unit 130, a list display control unit 140, a detailed display control unit 150, and a content storage unit 160 as shown in FIG. 2.

The touch panel 110 is a device for displaying information as well as capable of performing an operation on the displayed information by being touched by the operation tool. The touch panel 110 includes the display unit 112 for displaying information, a detection unit 114 for detecting proximity of an operation tool to, or contact of the same with the display surface of the display unit 112. The display unit 112 can use a liquid crystal display, an organic EL display and the like, for example. Moreover, the detection unit 114 can use a sensor for detecting change in capacitance, a sensor for detecting change in pressure on the display unit 112 and the like, for example. The detection unit 114 outputs a detection value which has been detected to the movement determination unit 120 as a detection result. The operation tool for performing an operation on information on the touch panel 110 may be a finger, a touch pen or the like, for example.

The movement determination unit 120 is a functional unit for determining a gesture of the operation tool based on the detection result by the detection unit 114. The movement determination unit 120 calculates the position and the moving speed of the operation tool on the display unit 112 and determines the gesture of the operation tool on the display screen of the display unit 112 from the detection result of the detection unit 114. Then, the movement determination unit 120 outputs an instruction for changing display content of the display unit 112 to the list display control unit 140 and the detailed display control unit 150 based on the gesture of the operation tool. Moreover, the movement determination unit 120 outputs a content acquisition instruction to the content acquisition unit 130 based on the gesture of the operation tool.

The content acquisition unit 130 is a functional unit for obtaining content from a content distribution server connected via a network. The content acquisition unit 130 obtains the specified content from the content distribution server based on the content acquisition instruction from the movement determination unit 120. Then, the content acquisition unit 130 outputs the obtained content to the list display control unit 140 and the detailed display control unit 150 as well as records the same in the content storage unit 160.

The list display control unit 140 is a functional unit for creating a list of contents displayed on the display unit 112 and for controlling the display of the list. The list of contents consists of the thumbnails of contents arranged in line, for example. The list display control unit 140 creates the list basically by using the content stored in the content storage unit 160, but can create the list by using the content information obtained by the content acquisition unit 130. The list display control unit 140 causes the display unit 112 to display the created list. The list display control unit 140 changes the display of the list according to the gesture of the operation tool determined by the movement determination unit 120.

The detailed display control unit 150 is a functional unit for controlling the display of content or detailed information. When it is determined that a thumbnail is selected from the list by the gesture of the operation tool determined by the movement determination unit 120, the detailed display control unit 150 causes the display unit 112 to display the content or detailed information corresponding to the selected thumbnail. Then, the detailed display control unit 150 changes the display of the content or detailed information according to the gesture of the operation tool determined by the movement determination unit 120.

The content storage unit 160 stores therein the content obtained by the content acquisition unit 130. Regarding each piece of content, the content storage unit 160 stores therein at least the latest content information of the obtained content, but can also store therein information of the content viewed by the user as a history in order to display a browsing history.

Such display processing apparatus 100 determines a gesture of the operation tool by the movement determination unit 120. Then, the display processing apparatus 100 can change the display of the list and the content displayed on the display unit 112 by controlling the same according to the gesture of the operation tool by the list display control unit 140 and the detailed display control unit 150.

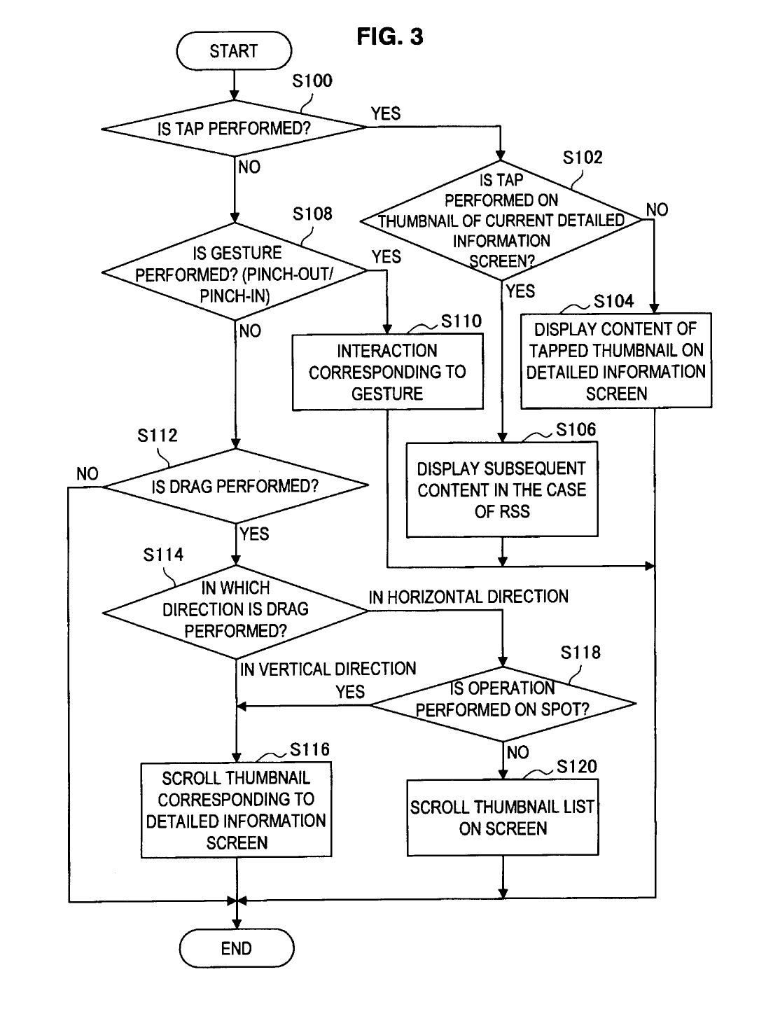

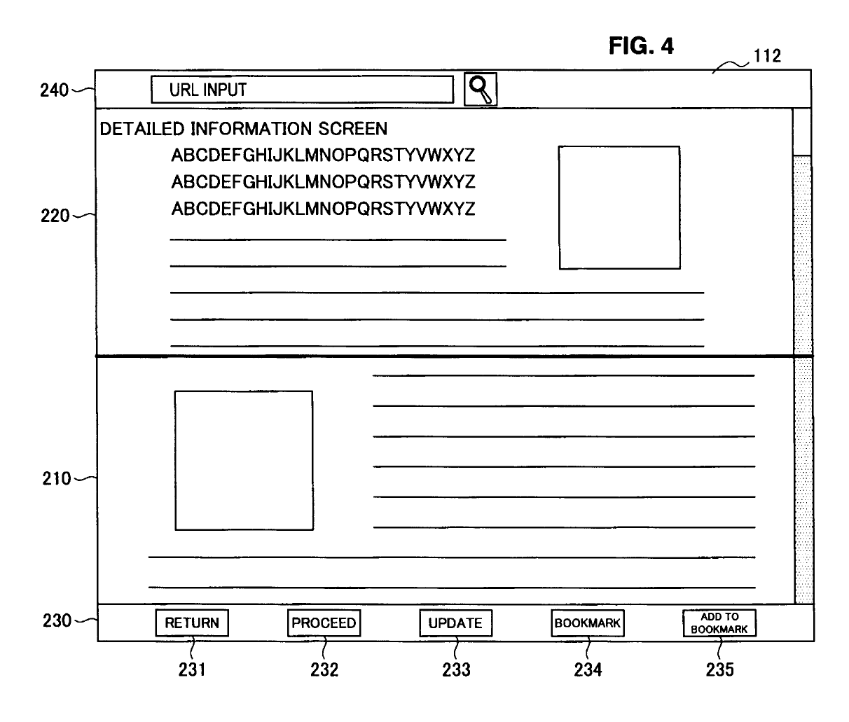

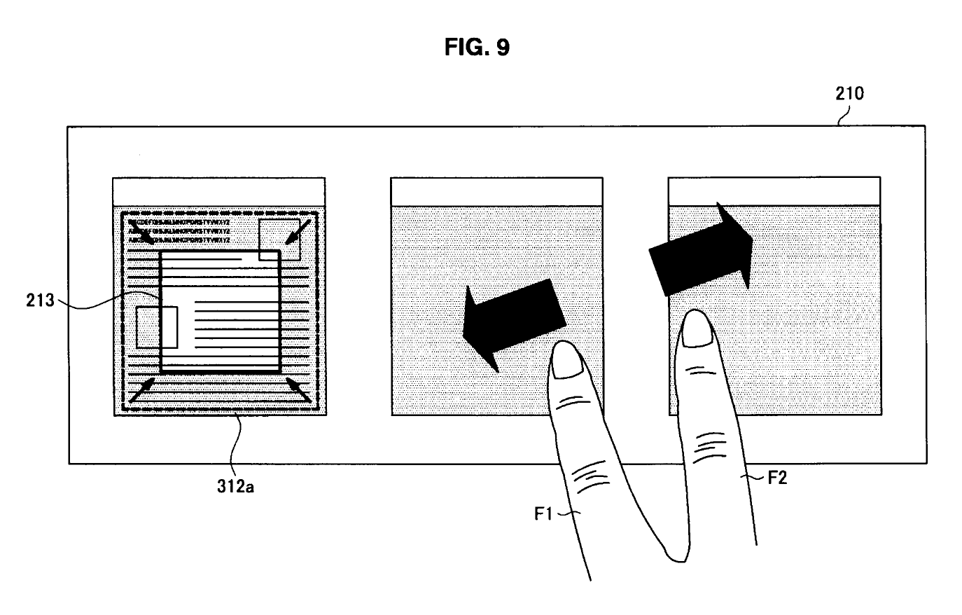

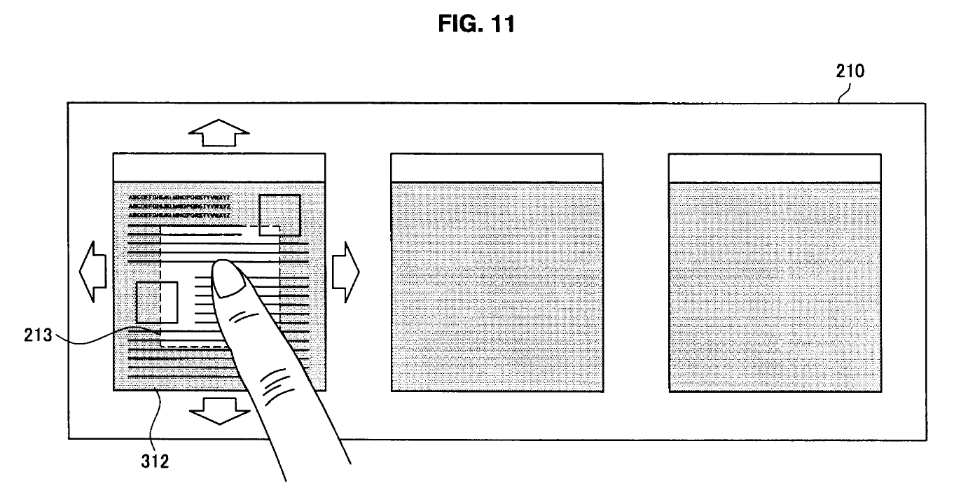

The functional configuration of the display processing apparatus 100 according to the present embodiment has been described above. Such display processing apparatus 100 functions so as to improve operability at the time of performing operation on the display content when a list of thumbnails of contents and the content corresponding to the thumbnail selected from the list are displayed in the two display areas of the display unit 112. In the following, a display processing method by the display processing apparatus 100 according to the present embodiment will be described based on FIG. 3 to FIG. 14. In addition, FIG. 3 is a flowchart showing the display processing method according to the present embodiment. FIGS. 4 to 8, 10, 12 to 14 are explanatory diagrams showing display examples of the screen which is display-controlled by the display processing apparatus 100. FIG. 9 is an explanatory diagram for explaining operations by pinch in/pinch out gestures. FIG. 11 is an explanatory diagram showing a scroll operation.

### <2. Display Control Method by Display Control Apparatus>

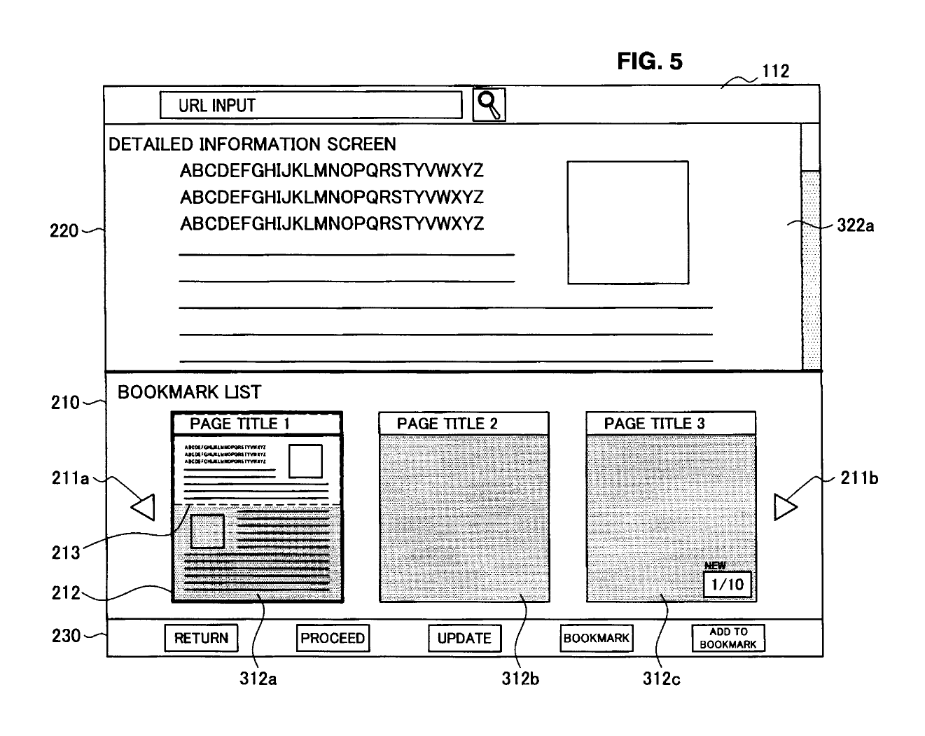

The display processing apparatus 100 according to the present embodiment includes two display areas 210 and 220 in the display unit 112 as described above. The display control apparatus 100 can cause each of the display areas 210 and 220 to display, in the two display areas 210 and 220, a piece of display content as shown in FIG. 4 and different pieces of display content as shown in FIG. 5. The display unit 112 can include an icon display area 230 for displaying an operation icon and an input area 240 for inputting an URL and the like in addition to the first display area 210 and the second display area 220 as shown in FIG. 4. An icon 231 for returning to the previous processing or the previous page, an icon 232 for proceeding to the next processing or the next page, and an icon 233 for obtaining the latest information are provided in the icon display area 230 are provided in the icon display area 230, for example. Furthermore, an icon 234 for displaying a bookmark, an icon 235 for adding the display content to the bookmark and the like are provided in the icon display area 230, for example.

The user touches the icon 234 for displaying a bookmark, for example with a finger which is an operation tool, in the state shown in FIG. 4. Then, for example, a list of bookmarked contents is displayed in the first display area 210 as shown in FIG. 5, changing from the state in which a piece of content is displayed in the two display areas 210 and 220. Then, the screen switches to the state in which the content is displayed only in the second display area 220. A plurality of, for example three, thumbnails 312a to 312c of contents are arranged in the horizontal direction of the screen and displayed in the first display area 210. In the case where the number of the contents included in the list exceeds the number of contents that can be displayed in the first display area 210, a thumbnail 312 of the content not displayed in the first display area 210 can be displayed by tapping a left button 211a or a right button 211b.

When the user touches the thumbnail 312 of the list, the content corresponding to the thumbnail selected by touching is displayed in the second display area 220. At this time, a selection frame 212 that indicates that the thumbnail 312 is selected can be additionally displayed on the thumbnail 312 of the content displayed in the second display area 220 among the thumbnails 312 displayed in the first display area 210.

Assume that, in such screen, the user touches the first display screen 210 with a finger. At this time, the movement determination unit 120 determines whether the gesture of the operation tool is a tap (step S100). The user can move the operation tool in a variety of ways on the first display area 210. The detection unit 114 of the touch panel 110 outputs a detection value that changes in accordance with the gesture of the operation tool to the movement determination unit 120. Then, the movement determination unit 120 determines the gesture of the operation tool based on the detection result of the detection unit 114 and causes the content acquisition unit 130, the list display control unit 140, and the detailed display control unit 150 to function according to the determination result.

The movement determination unit 120 determines that a tap has been performed in the case where a finger touches the surface of the display, and the position where finger touches the display surface is almost the same as the position where the finger leaves the surface of the display. When the movement determination unit 120 determines at the step 100 that a tap has been performed, the movement determination unit 120 then determines whether that movement has been performed on the thumbnail of the content displayed in the second display area 220 among the thumbnails 312 displayed in the first display area 210 (step S102). Here, “on the thumbnail” refers to on a specific area associated with each of the thumbnails. The specific area may be an area into which the first display area 210 is divided by the number of the thumbnails displayed on the first display area or may be an area within the framework of each of the thumbnails, for example as shown in FIG. 5. When the movement determination unit 120 determines at the step S102 that the tap has been performed on the thumbnail 312 of the content not displayed in the second display area 220, the movement determination unit 120 instructs the detailed display control unit 150 to display the content corresponding to the thumbnail on which the tap has been performed.

Assume that a thumbnail 312a of the content “page title 1” is selected from the list displayed in the first display area 210 as shown in FIG. 5, for example. At this time, the content 322a of the thumbnail 312a is displayed in the second display area 220. In addition, the selection frame 212 is added to the thumbnail 312a, and a part displayed in the second display area 220 is indicated by a spot 213. In this state, a tap is performed on the thumbnail 312 (e.g., a thumbnail 312b) other than the selected thumbnail 312a. Then, the movement determination unit 120 instructs the content acquisition unit 130 to obtain the latest content corresponding to the thumbnail 312 from the content distribution server.

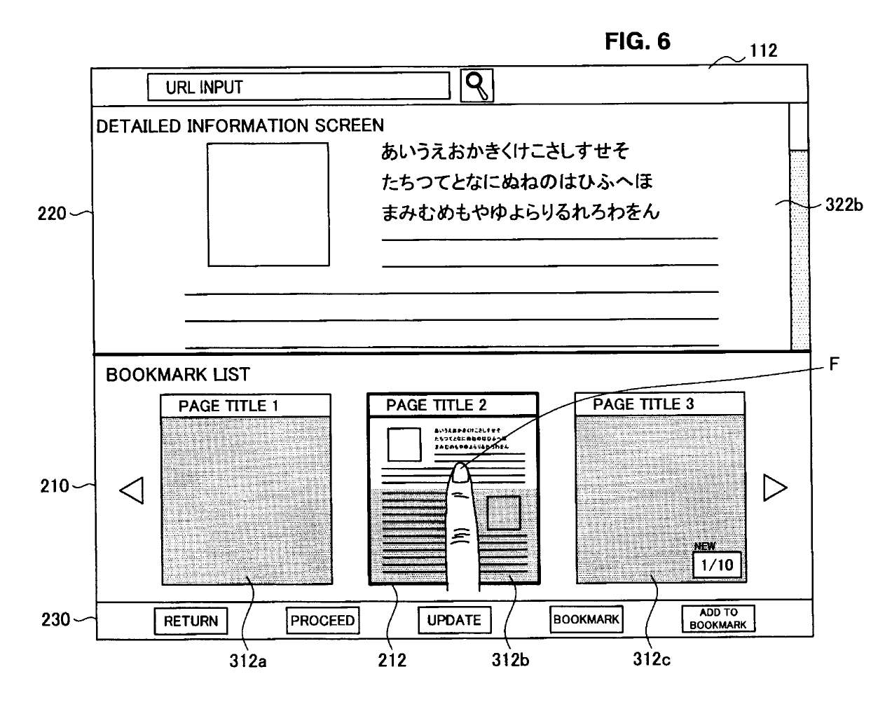

Then, when the content acquisition unit 130 obtains the latest content corresponding to the tapped thumbnail, the content acquisition unit 130 outputs the obtained information to the detailed display control unit 150 as well as records the same in the content storage unit 160. After that, the detailed display control unit 150 causes the content input from the content acquisition unit 130 to be displayed in the second display area 220. Moreover, the movement determination unit 120 instructs the list display control unit 140 to add the selection frame 212 to the thumbnail 312 of the content on which the tap has been performed as well as to indicate the area displayed in the second display area 220 by the spot 213. A display processing of the content corresponding to the newly selected thumbnail and a display change processing of the list are performed in this manner, and the screen display becomes the state as shown in FIG. 6. When the processing of the step S104 is completed, a processing shown in the flowchart is once terminated and the processing is started again from the step S100.

The latest content information newly recorded in the content storage unit 160 can be used for the thumbnails of the list. By this, the display of the thumbnails of the list can be updated. In addition, when the display control apparatus 100 is always connected with the content distribution server, the content acquisition unit 130 can obtain the latest content. At this time, the content acquisition unit 130 may be caused, for example, to obtain the latest information of the content at a predetermined time interval in the background, other than the case where a thumbnail is selected from the list. By this, even if the user does not view the content for a long period of time, the latest content can be displayed on the list.

On the other hand, when the movement determination unit 120 determines at the step S102 that the tap has been performed on the thumbnail 312 of the content displayed in the second display area 220, the movement determination unit 120 determines whether the content is RSS. Then, if the content is a document described in RSS, the movement determination unit 120 causes the content that is to be displayed subsequently to the content currently displayed in the second display area 220 to be displayed in the second display area 220 (step S106). RSS is a format for structurally describing the metadata of the heading or summary of a web site, and the title, address, heading, summary, updated time and the like of each page of the web site can be described in the document described in RSS. This enables update information of a plurality of web sites to be efficiently grasped, but a display control by the display control apparatus 100 according to the present embodiment enables the updated information of the plurality of web sites to be easily viewed.

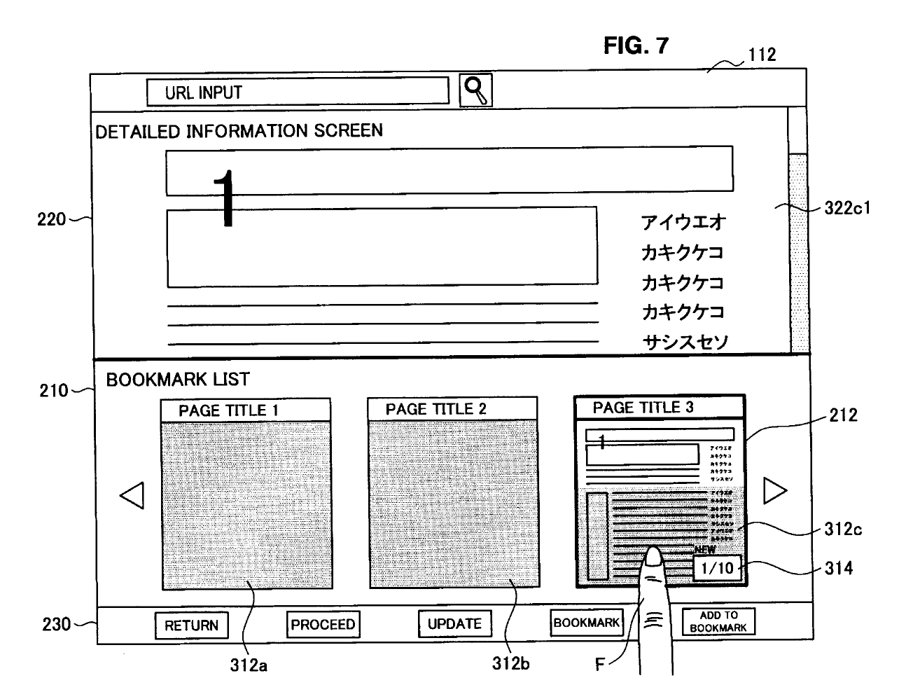

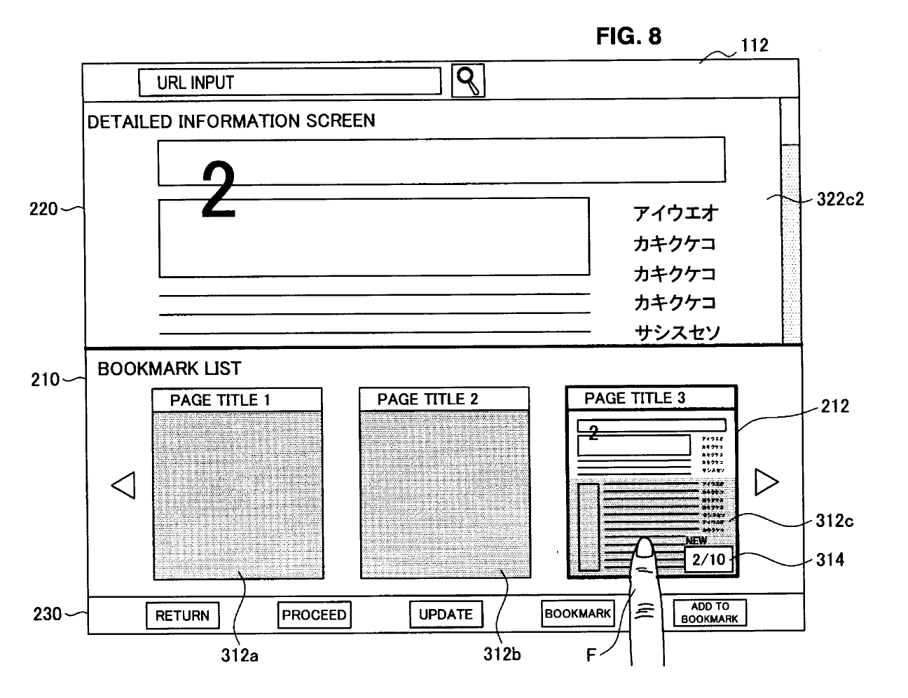

Assume that a thumbnail 312c is selected from the list and the content 322c1 corresponding to the thumbnail 312c is displayed in the second display area 220 as shown in FIG. 7, for example. At this time, when a tap is performed on the thumbnail 312c, the movement determination unit 120 determines whether the content corresponding to the thumbnail 312c is a document described in RSS. If the content is a document described in RSS, the movement determination unit 120 causes the content acquisition unit 130 to obtain the latest version 322c2 of the content that is to be displayed subsequently to the content currently displayed in the second display area 220. Then the detailed display control unit 150 causes the latest version 322c2 of the subsequent content obtained by the content acquisition unit 130 to be displayed in the second display area 220, as shown in FIG. 8.

In this manner, in the case where the thumbnail 312 displayed in the list is a document described in RSS, the user can cause the contents put in the document described in RSS to be sequentially displayed in the second display area 220. At this time, as shown in FIG. 7, there may be provided an RSS label 314 for indicating that the content corresponding to the thumbnail 312 is a document described in RSS. The RSS label 314 may display the number of contents put in the document described in RSS and a display number of the content currently displayed in the second display area 220 in a manner such as “a display number of the current content/the total number of contents”, for example. Then, at each time the entered content is sequentially displayed by the processing of the step S106, the RSS label 314 is changed such as from “ 1/10” to “ 2/10” to “ 3/10” and so on by the list display control unit 140. By this, the entry number of the content currently displayed in the second display area 220 can be notified to the user.

Moreover, an update mark (e.g., the word “NEW” above the RSS label 314 shown in FIG. 7) for indicating that the content displayed in the second display area 220 has been updated can be added to the RSS label 314. By this, it can be notified to the user that the latest content is currently displayed in the second display area 220.

When the processing of the step S106 is completed, the processing shown in the flowchart is once terminated and the processing is started again from the step S100.

The processing returns to the step S100, and if the movement determination unit 120 determines at the step 100 that a movement other than a tap has been performed, the movement determination unit 120 determines whether the movement is related with a predetermined display processing (step S108). Assume that, in the present embodiment, the movement of pinch in/pinch out is related with the scaling-down/scaling-up processing of display content. The “pinch-in” refers to a movement of two fingers in contact with the screen narrowing the distance therebetween, and the “pinch-out” refers to a movement of two fingers F1 and F2 in contact with the screen widening the distance therebetween, as shown in FIG. 9. In the case where the movement of pinch-in is detected, the detailed display control unit 150 reduces the size of the content displayed in the second display area 220. On the other hand, in the case where the movement of pinch-out is detected, the detailed display control unit 150 enlarges the size of the content displayed in the second display area 220.

At this time, the size of the spot 213 put on the thumbnail 312 of the selected content changes in response to the movement of pinch-in/pinch-out. That is, when the size of the spot 213 grows when the movement of pinch-in is performed thereon, and the size of the spot 213 diminishes when the movement of pinch-out is performed thereon. In addition, the movement of the operation tool can be determined from a detection result by the detection unit 114, as described above. In the present embodiment, an operation on screen by a movement other than the movement of pinch-in/pinch-out may be possible by relating a movement of the operation tool such as dragging or multiple tapping on the display surface with a predetermined display processing.

In the case where it is determined at the step S108 that a gesture related with a predetermined display processing has been performed, the display processing corresponding to the gesture is performed (step S110). Then, when the processing of the step S110 is completed, the processing shown in the flowchart is once terminated and the processing is started again from the step S100.

On the other hand, when it is determined at the step S108 that the movement of the operation tool is not a gesture related with a predetermined display processing, the movement determination unit 120 determines whether the movement of the operation tool is a drag (step S112). Here, the “drag” is a movement of the operation tool moving while keeping in contact with the screen. The movement of drag is related with the processing of scrolling or moving the content displayed on the display unit 112. In the case where it is determined at the step S112 that the movement of the operation tool is not a drag, the processing shown in the flowchart is once terminated without performing the display change processing and the processing is started again from the step S100.

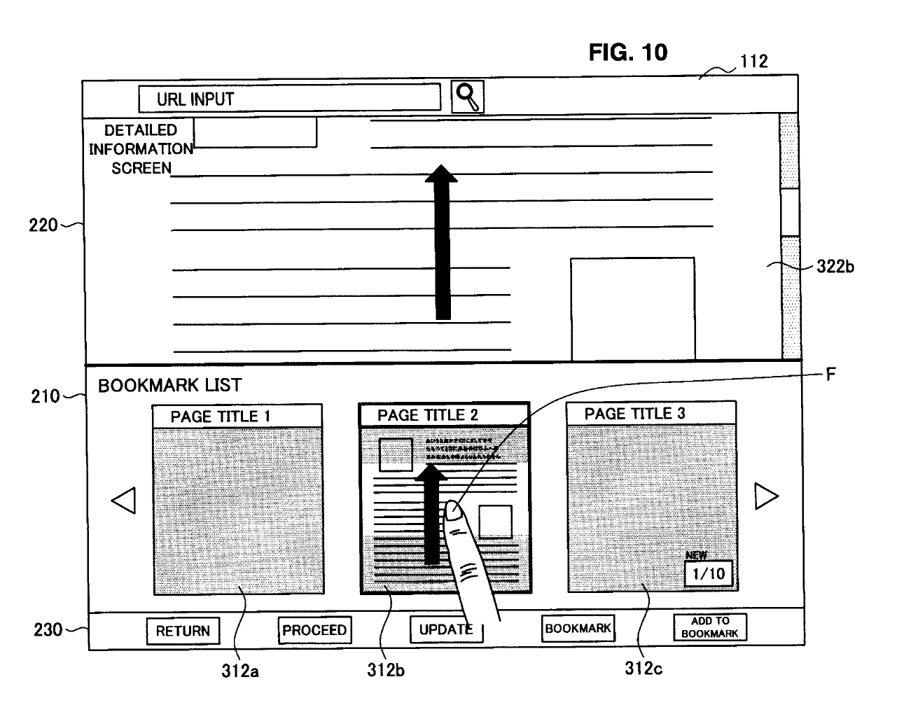

When it is determined at the step S112 that the movement of the operation tool is a drag, the direction of the drag is then determined (step S114). The direction of the drag can be determined from a detection result by the detection unit 114. When the movement determination unit 120 determines that the drag is performed in the vertical direction, the detailed display control unit 150 causes the content displayed in the second display area 220 to be scrolled in the direction of the drag, as shown in FIG. 10 (step S116). At the same time, the list display control unit 140 scrolls the thumbnail 312 of the content displayed in the second display area 220 and makes what is displayed on the thumbnail displayed within the spot 213 correspond to the content displayed in the second display area 220. In this manner, the user can operate the display of the content displayed in the second display area 220 in the first display area 210 for selecting a piece of content whose detailed information is to be displayed in the second display area 220. Then, when the processing of the step S116 is completed, the processing shown in the flowchart is once terminated and the processing is started again from the step S100.

On the other hand, when the movement determination unit 120 determines at the step S114 that the drag is performed in the horizontal direction, whether the movement of the operation tool is performed on the thumbnail 312 of the content displayed in the second display area 220 (step S118). At the step S118, by the drag in the horizontal direction, it is determined whether to scroll the content displayed in the second display area 220 in the horizontal direction or to scroll the list displayed in the first display area 210.

For example, when there is content outside the spot 213 which is supposed to be displayed in the selected thumbnail 312 to which the finger F contacts, as shown in FIG. 11, the display content can be scrolled up, down, left, or right in order to display the content outside the spot 213 in the second display area 220. On the other hand, the list of thumbnails displayed in the first display area 210 can be scrolled by the left button 211a and the right button 211b, but the list can be moved by moving the finger F in the horizontal direction within the first display area 210. In this manner, when the movement of dragging the operation tool in the horizontal direction is related with two display processing, it has to be determined that which display processing is to be performed.

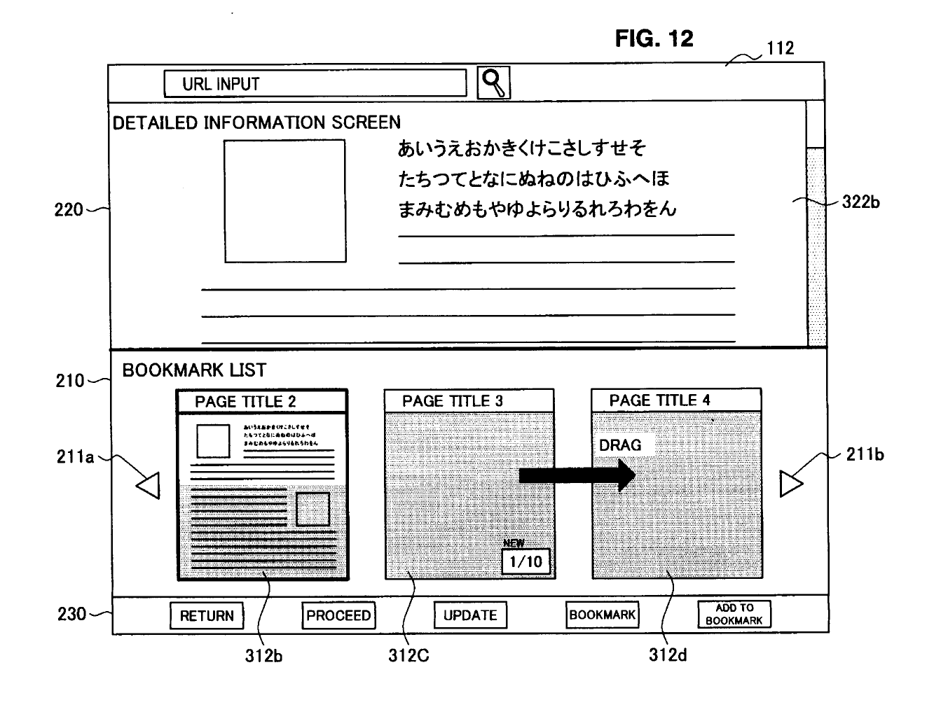

In the present embodiment, when a drag is performed in the horizontal direction on the thumbnail 312 of the content displayed in the second display area 220, the detailed display control unit 150 scrolls the content displayed in the second display area 220 in the horizontal direction (step S116). On the other hand, in the first display area 210, when a drag is performed in the horizontal direction in the area outside the thumbnail 312 of the content displayed in the second display area 220, the list display control unit 140 scrolls the list displayed in the first display area 210 in the horizontal direction, as shown in FIG. 12 (step S120). Then, when the processing of the step S116 or S120 is completed, the processing shown in the flowchart is once terminated and the processing is started again from the step S100.

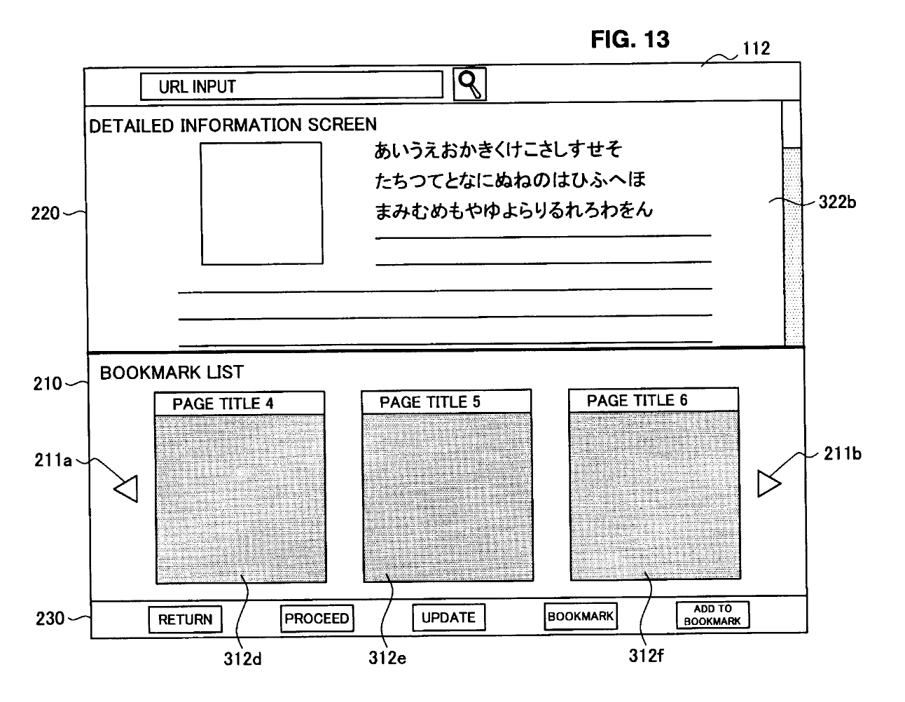

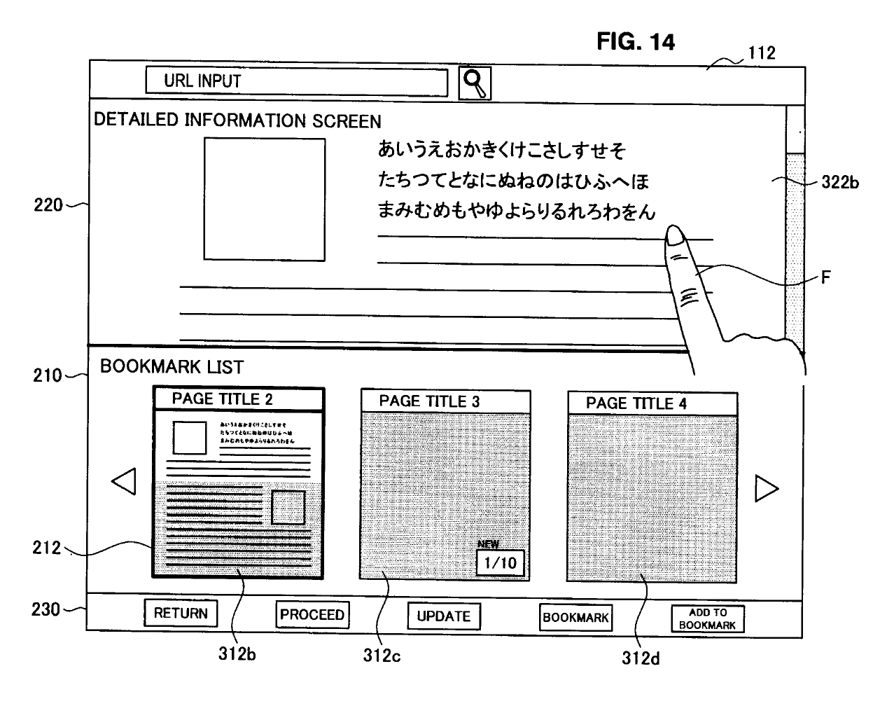

In addition, at the step S120, there may be a case where the thumbnail 12b corresponding to the content 322b displayed in the second display area 220 disappears from the first display area 210 by a list being scrolled in the horizontal direction, as shown in FIG. 13. At this time, as shown in FIG. 14, the list display control unit 140 may cause the thumbnail 312b corresponding to the content displayed in the second display area 220 to be displayed within the first display area 210 when the user touches the second display area 220 with the finger F, for example. By this, the thumbnails of the list displayed in the first display area 210 and the content displayed in the second display area 220 may be easily displayed on the display unit 112 corresponding to each other.

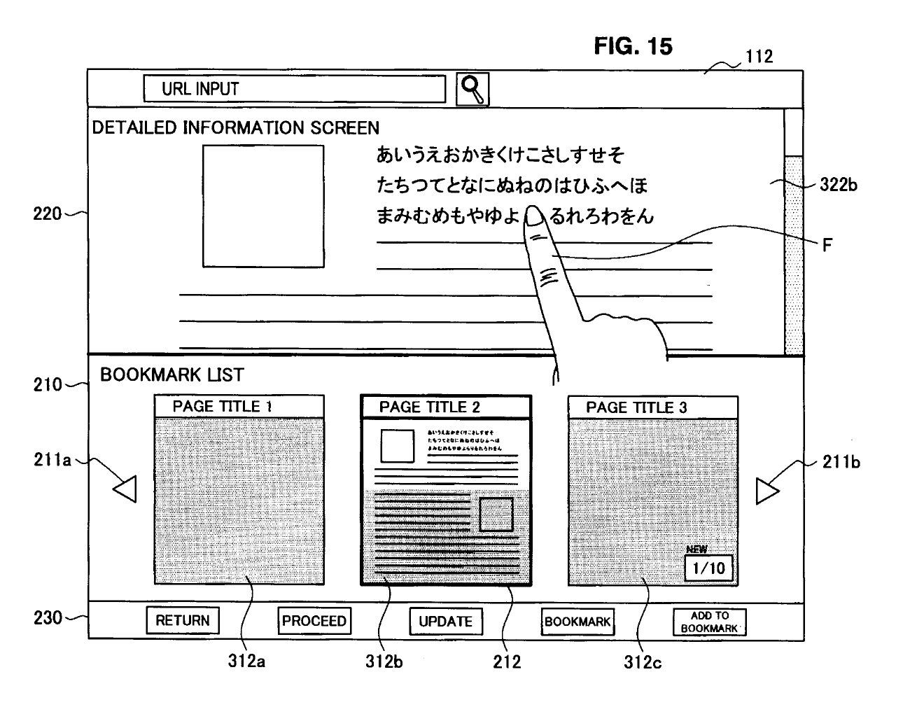

The display control method by the display control apparatus 100 according to the present embodiment has been described above. According to the display control method, in the first display area 210 on which the list of contents is displayed, there can be performed the operation of selecting content from the list and the operation on the display content displayed in the second display area 220. By this, operability can be improved without moving the operation tool between display areas. Furthermore, other than the display control described above, the display control apparatus 100 can perform display control for improving the operability of performing an operation on the display content displayed on the display unit 112. In the following, examples of a display control by the display control apparatus 100 is shown based on FIGS. 15 to 19.

### [Display Control by Operation in Second Display Area]

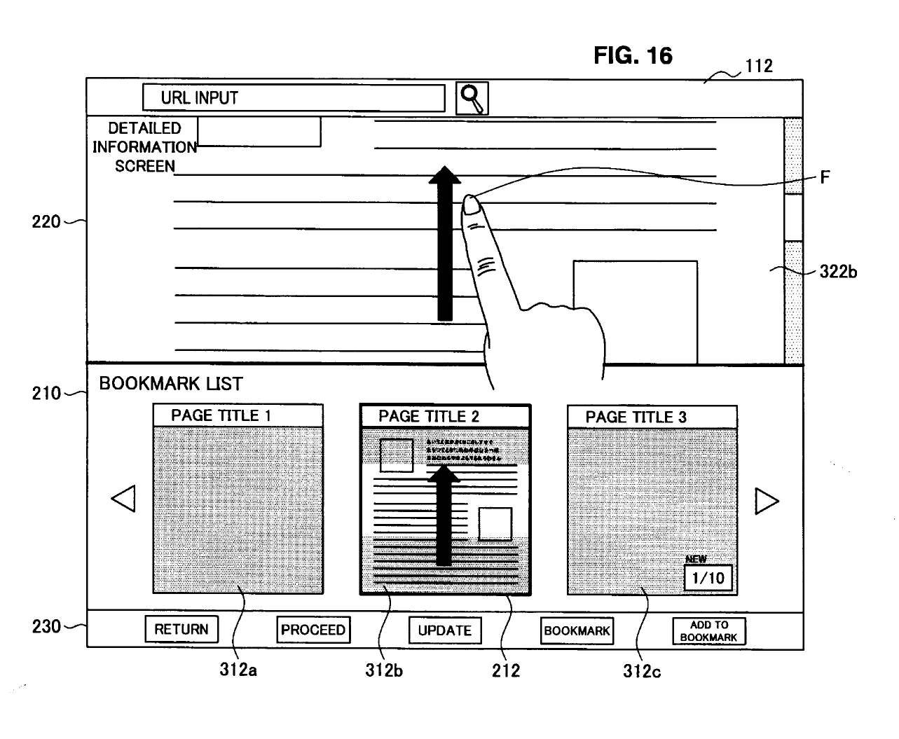

First, a display control by an operation in the second display area 220 will be described based on FIG. 15 and FIG. 16. In addition, FIG. 15 and FIG. 16 are explanatory diagrams each of which shows a display control method by an operation in the second display area 220 according to the present embodiment.

As described above, with the display control method by the display control apparatus 100, there can be performed the operation of selecting content from the list and the operation on the display content displayed in the second display area 220, in the first display area 210 on which the list of contents is displayed. By this, operability can be improved without moving the operation tool between display areas. Here, since the second display area 220 is also the touch panel 110, an operation on the content displayed in the second display area 220 can be also performed by moving the operation tool in the second display area 220.

For example, assume that the user touches with the finger F the second display area 220 on which the content 322b is displayed and drags the finger F upward, as shown in FIG. 15. Then, the content 322b displayed in the display area 220 is scrolled up by the detailed display control unit 150, as shown in FIG. 16. At this time, the list display control unit 140 scrolls the thumbnail 312b corresponding to the content displayed in the second display area 220 such that the part corresponding to the content displayed in the second display area 220 is displayed within the spot 213. In this manner, the display content in the first display area 210 is changed simultaneously by the operation in the second display area 220, and thereby the movement of the operation tool moving between the display areas is reduced and the operability can be improved.

### [Addition of Bookmark]

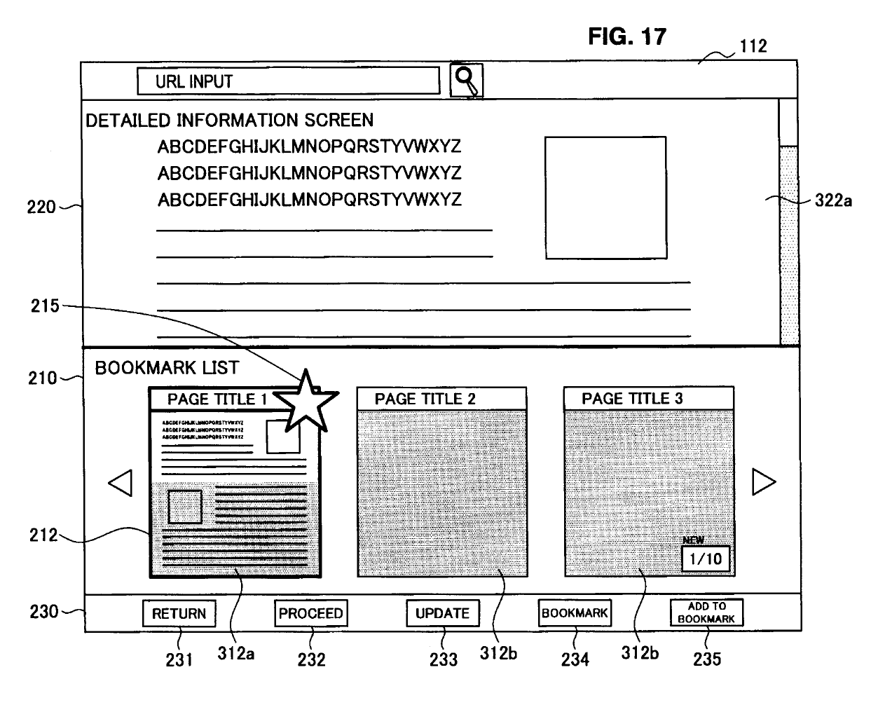

Next, a processing of adding a bookmark will be described based on FIG. 17. In addition, FIG. 17 is an explanatory diagram for explaining the processing of adding a bookmark.

In the present embodiment, description is made taking a case where the list displayed in the first display area 210 is a list of bookmarked contents as an example. When the user views contents, the user can bookmark content which the user likes or content likely to be frequently visited, in order to easily access thereto again. The bookmarked content can be easily selected by displaying the list of bookmarked contents. For example, when bookmarking the content displayed as shown in FIG. 4, the user touches with the finger F the icon 235 for adding the displayed content to the bookmark, the icon 235 being displayed in the icon display area 230. Then, as shown in FIG. 17, the list of bookmarked contents are displayed in the first display area 210 and the display content having been displayed in the first display area 210 and the second display area 220 is displayed only in the second display area 220.

Then, the thumbnail 312a of the content displayed in the second display area 220 is added to the list of contents displayed in the first display area 210. The selection frame 212 is additionally displayed to the thumbnail 312a since the content 322a corresponding thereto is displayed in the second display area 220. Moreover, an addition mark 215 may be added to the added thumbnail 312a as shown in FIG. 17, for example. In this manner, the user can easily bookmark the desired content.

### [Display Processing Example in the Case of Selecting Link Destination Displayed in the Detailed Information]

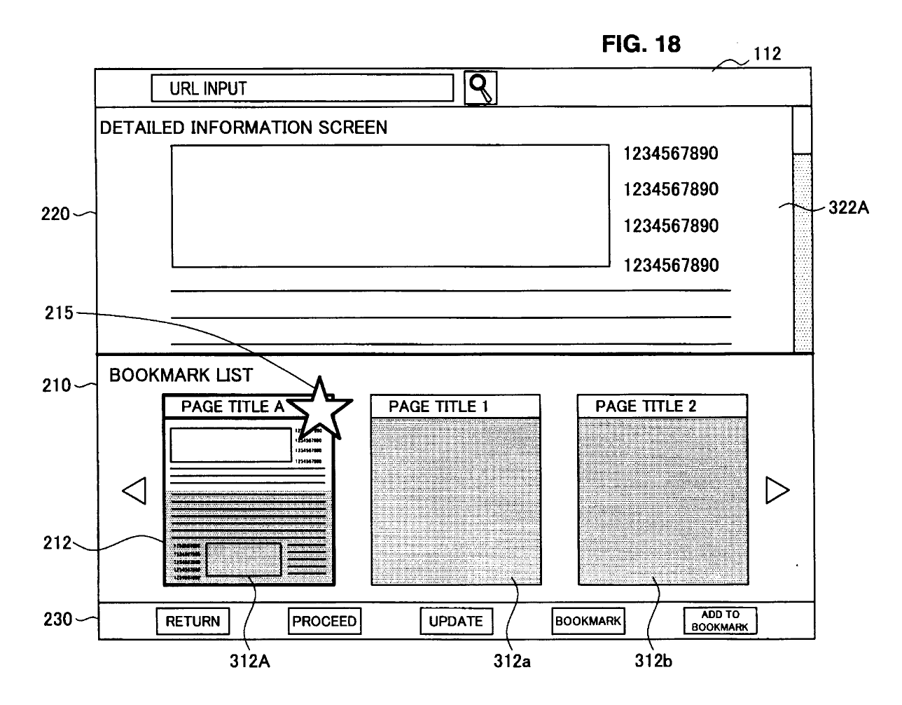

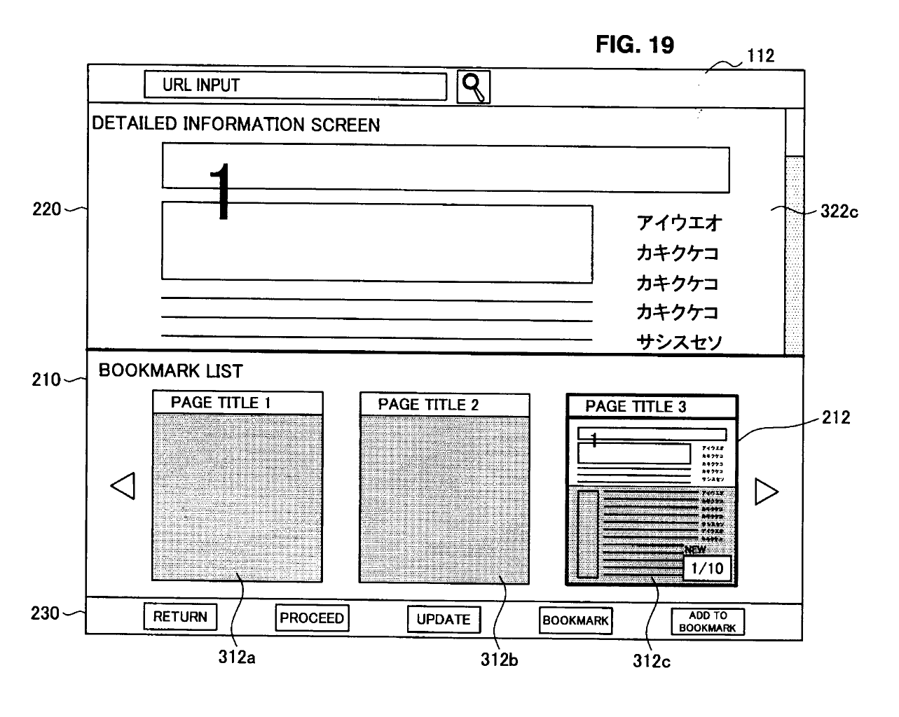

Furthermore, a display processing example in the case of selecting a link destination from the content displayed in the second display area 220 will be described based on FIG. 18 and FIG. 19. In addition, FIG. 18 is an explanatory diagram showing a display processing in the case where the content displayed in the second display area 220 is not bookmarked. FIG. 19 is an explanatory diagram showing a display processing in the case where the content displayed in the second display area 220 is bookmarked.

For example, as shown in FIG. 5, when one of the thumbnails 312 is selected from the list displayed in the first display area 210, the content corresponding to the selected thumbnail 312 is displayed in the second display area 220. Assume that, at this time, a link destination included in the content displayed in the second display area 220 is selected. Then, content information of the link destination is obtained by the content acquisition unit 130 and the obtained content is displayed in the second display area 220 by the detailed display control unit 150.

Here, when the content of the link destination displayed in the second display area 220 is not bookmarked, the list display control unit 140 additionally displays a thumbnail 312A of the content of the link destination to the list displayed in the first display area 210, as shown in FIG. 18. Then, similarly to the case of adding a bookmark, the list display control unit 140 adds the selection frame 212 or an addition mark 215 to the thumbnail 312A. When bookmarking the content, the user only has to touch with the finger F the icon 235 which is to be bookmarked. In this manner, by adding to the list the thumbnail 312A of the content of the link destination, the bookmarking of the content can be easily performed. In addition, in the case of selecting the icon 231 for returning, without selecting the icon 235 for adding to a bookmark, the content is not bookmarked and the thumbnail is also deleted from the list of thumbnails of the bookmarked contents by the list display control unit 140.

On the other hand, in the case where the content of the link destination displayed in the second display area 220 is bookmarked, the list display control unit 140 performs display control such that the thumbnail 312 of the content of the link destination is displayed within the first display area 210. Assume that the content of the link destination displayed in the second display area 220 is bookmarked as shown in FIG. 19, for example. At this time, the list display control unit 140 scrolls the list in the first display area 210 and causes the thumbnail 312c of the content of the link destination to be displayed within the first display area 210. Then, the list display control unit 140 adds the selection frame 212 to the thumbnail 312c. In this manner, the list display control unit 140 changes the display of the thumbnail 312c on the list along with the display content 322c. This enables the user to perform an operation, also in the first display area 210, on the display content displayed in the second display area 220. This also enables to prevent the same content from being bookmarked redundantly.

In this manner, according to the display control method of the display control apparatus 100 according to the present embodiment, operability of the display content displayed in the two display areas can be improved.

The display control method by the display control apparatus 100 according to the present embodiment has been described above. When the list in the form of thumbnails is displayed in the first display area 210 and the content corresponding to a thumbnail selected from the list is displayed in the second display area 220, the display control apparatus 100 can perform, within the same display area, the selection of the thumbnail and an operation on the content. Specifically, content display in the second display area 220 is scrolled by scrolling the thumbnail selected from the list, and the selection operation of the thumbnail and a scroll operation of the content can be performed in a series. Especially, when the two display areas 210 and 220 are two different screens independent of each other, there can be reduced the transfer of a hand from the screen on which the list of thumbnails is displayed to the screen on which the content is displayed.

This enables to reduce user's operational burden or operation steps at the time of finding desired content from the list on which a plurality of thumbnails are displayed. Moreover, other than the selection of thumbnail and the operation on the content, the display content of the second display area 220 can be changed in the first display area 210 on which the list is displayed, such as switching pages by tapping the thumbnail of a document described in RSS, for example. Furthermore, by using such display control apparatus 100, the advantage of the device using the touch panel 110 that an operation can be performed on an object itself.

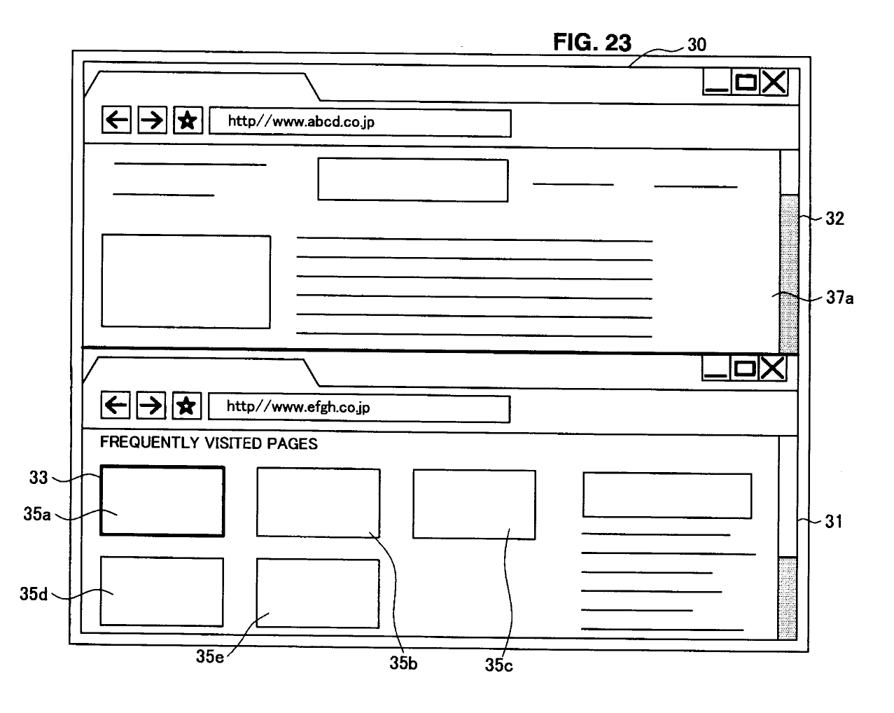

In addition, in the present embodiment, the list of the contents displayed in the first display area 210 is a list of the bookmarked contents, but in the case of a history display, the display mode of the list can be changed. For example, as shown in FIG. 5, thumbnails of respective pages may be arranged and displayed, as well as history information of the selected thumbnail may be arranged and displayed on the bottom or either side of the selected thumbnail. This enables to view the past content easily. Moreover, the screen display mode as in the present embodiment can be applied to a case of using a plurality of tabs of a browser and viewing each page by switching the tabs, for example. Also in the case of viewing a page in a screen display mode as shown in FIG. 23, by using the display control apparatus 100 of the present embodiment, the content corresponding to the thumbnail selected on a first display surface 31 can be displayed on a second display surface 32, as well as an operation on the content displayed on the second display surface 32 can be performed in the first display surface 31.

When there are a plurality of lists to be displayed in the first display area 210 (e.g., case of a list of bookmarked contents and a list of each page displayed in a tab browser), a type of the list which is displayed in the first display area 210 may be displayed. For example, in the case where the list of bookmarked contents is displayed in the first display area 210, a list name such as “a bookmark list” may be displayed in the first display area 210, as shown in FIG. 5. Alternatively, the list displayed in the first display area 210 may be switched by providing a tab browser within the first display area 210.

### <3. Hardware Configuration Example>

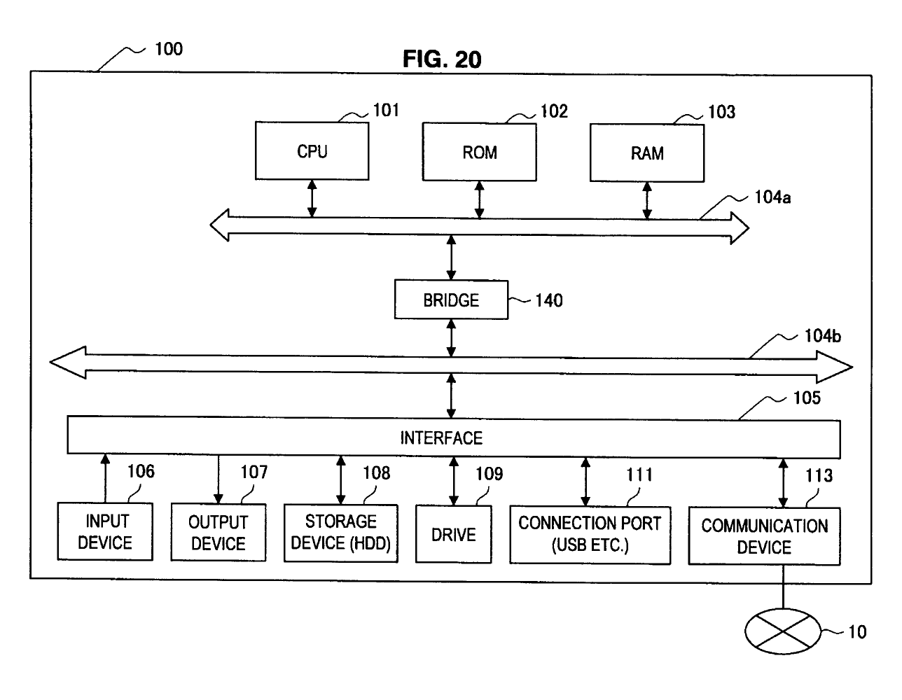

The display control by the display control apparatus 100 according to the present embodiment can be executed by hardware or by software. In this case, the display control apparatus 100 also includes a computer as such shown in FIG. 20. In the following, based on FIG. 20, an example of a hardware configuration of the display control apparatus 100 according to the present embodiment will be described. In addition, FIG. 20 is a hardware configuration diagram showing the display control apparatus 100 according to the present embodiment.

The display control apparatus 100 of the present embodiment includes a CPU (Central Processing Unit) 101, a ROM (Read Only Memory) 102, a RAM (Random Access Memory) 103, and a host bus 104a. Moreover, the display control apparatus 100 includes a bridge 104, an external bus 104b, an interface 105, an input device 106, an output device 107, a storage device (HDD) 108, a drive 109, a connection port 111, and a communication device 113.

The CPU 101 functions as an arithmetic processing unit and a control unit and controls the entire operation within the display control apparatus 100 according to a variety of programs. Moreover, the CPU 101 may be a microprocessor. The ROM 102 stores therein programs, calculation parameters and the like used by the CPU 101. The RAM 103 temporarily stores therein programs used in the execution of the CPU 101 and parameters that change appropriately in the execution, and the like. These are interconnected via the host bus 104a including a CPU bus and the like.

The host bus 104a is connected to the external bus 104b such as a PCI (Peripheral Component Interconnect/Interface) bus via the bridge 104. Incidentally, the host bus 104a, the bridge 104, and the external bus 104b are not necessarily configured separately and the functions thereof may be mounted on one bus.

The input device 106 includes an input means for inputting information by a user such as a mouse, a keyboard, a touch panel, a button, a microphone, a switch, and a lever and an input control circuit for generating an input signal based on input by the user and outputting the input signal to the CPU 101. The user of the display control apparatus 100 can input various types of data into and give an instruction for performing processing operation to the display control apparatus 100 by operating the input device 106. In the present embodiment, the input device 106 is configured as the touch panel 110 as shown in FIG. 2.

The output device 107 includes, for example, a display device such as a CRT (Cathode Ray Tube) display device, a liquid crystal display (LCD) device, an OLED (Organic Light Emitting Display) device and a lamp. Furthermore, the output device 107 includes an audio output device such as a speaker and a headphone. In the present embodiment, the display unit 112 is provided as the output device 107 as shown in FIG. 2.

The storage device 108 is a device for data storage configured as an example of a storage unit of the display control apparatus 100. The storage device 108 may include a storage medium, a recording device for recording data in the storage medium, a reading device for reading out the data from the storage medium, and a deletion device for deleting the data recorded in the storage medium. The storage device 108 includes a HDD (Hard Disk Drive), for example. This storage device 108 drives a hard disk and stores therein the programs or various types of data executed by the CPU 101.

The drive 109 is a reader/writer for storage medium and is built into or attached outside the display control apparatus 100. The drive 109 reads out information recorded in a removable recording medium attached thereto such as a magnetic disk, an optical disk, a magneto-optical disk, or a semiconductor memory, and outputs the information to the RAM 103.

The connection port 111 is an interface connected to an external device and is a connection port capable of transmitting data (/and is a connection port capable of transmitting data to an external device) to/from the external device via a USB (Universal Serial Bus) and the like. Moreover, the communication device 113 is a communication interface including a communication device for connecting to a communication network 10 or the like, for example. Moreover, the communication device 113 may be a communication device designated for wireless LAN (Local Area Network), a communication device designated for wireless USB or a wire communication device for wire or cable communication.

Although a preferred embodiment of the present invention is described in the foregoing with reference to the drawings, the present invention is not limited thereto. It should be understood by those skilled in the art that various modifications, combinations, sub-combinations and alterations may occur depending on design requirements and other factors insofar as they are within the scope of the appended claims or the equivalents thereof.

For example, in the above-described embodiment, the first display area 210 and the second display area 220 of the display unit 112 were arranged one above the other, for example, as shown in FIG. 1, but the present invention is not limited to the example. For example, the first display area 210 and the second display area 220 of the display unit 112 may be arranged adjacent to each other in the horizontal direction. Moreover, in the above-described embodiment, at the steps S114 to S120, when the drag of the operation tool was performed in the vertical direction, the display control apparatus 100 scrolled the content in the second display area 220 in the vertical direction, and when the drag of the operation tool was performed in the horizontal direction, the display control apparatus 100 determined whether to perform a scroll processing of the content or the move processing of the list and executed a processing corresponding to the operation. However, the present invention is not limited to the example, and the list may be composed by arranging the thumbnails of contents in the vertical direction, for example. In this case, when the drag of the operation tool is performed in the vertical direction, it has to be determined whether to perform a scroll of the content displayed in the second display area 220 or a scroll of the list.

The present application contains subject matter related to that disclosed in Japanese Priority Patent Application JP 2009-098412 filed in the Japan Patent Office on Apr. 14, 2009, the entire content of which is hereby incorporated by reference.

What is claimed is:

1. A display control apparatus comprising:
a detection unit for detecting proximity of an operation tool to, or contact of the operation tool with, a display unit including a first display area on which an object list in which a plurality of objects are arranged is displayed and a second display area on which the content of the object is displayed;
a movement determination unit for determining a movement of the operation tool based on the detection result by the detection unit;
a list display control unit for controlling a display of the object list displayed in the first display area based on the determination result by the movement determination unit; and
a detailed display control unit for controlling a display of the second display area based on the determination result by the movement determination unit,
wherein when the movement determination unit determines that one of the objects is selected from the object list displayed in the first display area, the detailed display control unit displays the content of the selected object in the second display area, and
wherein the detailed display control unit changes a display of the content of the object displayed in the second display area based on the movement of the operation tool in the first display area determined by the movement determination unit.

2. The display control apparatus according to claim 1, comprising:
an acquisition unit for obtaining the latest content of the object from an object distribution server which distributes objects and which is connected; and
a storage unit for storing therein the object obtained by the acquisition unit,
wherein the list display control unit displays in the first display area the object list created by using the latest objects among the objects stored in the storage unit,
wherein when determining that one of the objects is selected from the object list displayed in the first display area, the movement determination unit causes the acquisition unit to obtain the latest content of the selected object, and
wherein the detailed display control unit displays in the second display area the latest content of the selected object obtained by the acquisition unit.

3. The display control apparatus according to claim 1, wherein
when being in a communicable state with the object distribution server, the acquisition unit obtains the latest content of the object stored in the storage unit and records the latest content in the storage unit at a predetermined timing.

4. The display control apparatus according to claim 1, wherein
when the movement determination unit determines that, in the first display area, there is a movement of moving the operation tool in a first direction which is a direction substantially orthogonal to an arrangement direction of the objects which composes the object list, the detailed display control unit scrolls the content of the object displayed in the second display area in the first direction.

5. The display control apparatus according to claim 1, wherein
when the movement determination unit determines that, in the first display area, there is a movement of moving the operation tool in a second direction, which is the arrangement direction of the object, within an area corresponding to the selected object, the detailed display control unit scrolls the content of the object displayed in the second display area in the second direction.

6. The display control apparatus according to claim 1, wherein
when the movement determination unit determines that, in the first display area, there is a movement of moving the operation tool in the second direction, which is the arrangement direction of the object, outside the area corresponding to the selected object, the list display control unit scrolls the object list displayed in the first display area in the second direction.

7. The display control apparatus according to claim 6, wherein
when the object in the object list corresponding to the content of the object displayed in the second display area is moved outside the first display area, and the movement determination unit determines a contact of the operation tool with the second display area, the list display control unit displays the object list such that the object corresponding to the content of the object displayed in the second display area is displayed.

8. The display control apparatus according to claim 1, wherein
when the content of the object selected from the object list is a plurality of simplified information, the detailed display control unit sequentially displays in the second display area detailed information corresponding to the simple information at every time the movement detection unit detects a predetermined movement of the operation tool in the area corresponding to the selected object in the first display area.

9. A display control method comprising the steps of:
detecting proximity of an operation tool to, or contact of the operation tool with, a display unit including a first display area on which an object list in which a plurality of objects are arranged is displayed and a second display area on which the content of the object is displayed;
determining a movement of the operation tool based on a detection result;
displaying the object list in the first display area based on a determination result;
displaying the content of the selected object in the second display area when one of the objects is selected from the object list displayed in the first display area; and
changing a display of the content of the object displayed in the second display area based on the movement of the operation tool in the first display area.

10. A computer program for causing a computer to function as a display control apparatus including:
a movement determination means for determining a movement of an operation tool based on a detection result by a detection unit for detecting proximity of the operation tool to, or contact of the operation tool with, a display unit including a first display area on which an object list in which a plurality of objects are arranged is displayed and a second display area on which the content of the object is displayed;
a list display control means for controlling a display of the object list displayed in the first display area based on the determination result by the movement determination means; and
a detailed display control means for controlling a display of the second display area based on the determination result by the movement determination means,
wherein when it is determined that one of the objects is selected from the object list displayed in the first display area by the movement determination means, the detailed display control means displays the content of the selected object in the second display area, and
wherein the detailed display control means changes a display of the content of the object displayed in the second display area based on the movement of the operation tool in the first display area determined by the movement determination means.
